(19) United States
(12) Patent Application Publication
(10) Pub. No.: US 2004/0157181 A1
(43) Pub. Date: Aug. 12, 2004

(54) METHOD FOR MANUFACTURING CEMENT CLINKER

(76) Inventors: John R. Arnold, Fort Wayne, IN (US); Horace H. Compton, Leeds, AL (US); Larry J. Parker, Fredonia, KS (US); Oscar Tavares, Ann Arbor, MI (US)

Correspondence Address: BURNS, DOANE, SWECKER & MATHIS, L.L.P., P.O. Box 1404, Alexandria, VA, 22313-1404, US

(21) Appl. No.: 10/361,584

(22) Filed: Feb. 11, 2003

(51) Int. Cl. F27B 15/00

(52) U.S. Cl. 432/58; 432/14; 106/703; 106/744

(57) ABSTRACT

A method of manufacturing cement clinker includes a rotary cement kiln having a feed end, a mid-kiln feed location, and a burning end. The rotary kiln is tilted downwardly from the feed end to the burning end so that material introduced into the feed end travels downwardly to the burning end. Heat is directed at the burning end of the rotary kiln. Raw feed material is introduced in the feed end of the rotary kiln. Calcined material having a particle diameter of up to 12 inches is introduced at the mid-kiln feed location. The mid-kiln feed location is arranged in a calcining zone of the rotary kiln.

### FIELD OF THE INVENTION

The present invention generally relates to a method of manufacturing cement clinker. More particularly, the present invention pertains to a method of manufacturing cement clinker using calcined or other materials, which are fed at a mid-kiln feed location.

### BACKGROUND OF THE INVENTION

Portland cement has been used in the United States for over a century. Portland cement is primarily made from a combination of calcareous materials, such as limestone and chalk, and argillaceous materials containing silica (SiO₂) and alumina (Al₂O₃), such as clay, sand, and shale. Limestone is a common sedimentary rock made primarily of calcium carbonate (CaCO₃). Chalk is also a significant source of CaCO₃. Both limestone and chalk contain calcite, which is a common crystalline form of natural CaCO₃ and the basic constituent of limestone and chalk.

The calcareous and argillaceous materials are typically ground to a very fine powder, mixed in predetermined proportions, and fed into a rotary kiln. These materials are defined as the raw feed materials. As used herein, raw feed materials are materials used for the manufacture of cement and which have not previously been exposed to a thermal treatment. The raw feed materials can be fed either as a wet or a dry slurry.

The rotary kiln is tilted downwardly from a feed end to a burning end. The raw feed materials are fed into the feed end of the rotary kiln. As the raw feed materials move down the rotary kiln, the temperature increases so that various chemical changes take place along the kiln. At between about 450 and 800° C., decomposition of clayish materials takes place. At between about 650 and 900° C., decomposition of calcite or calcining occurs. Calcining is defined as heating to a high temperature, but below the melting point, causing loss of moisture, oxidation reactions occur, and the decomposition of carbonates and other compounds. During calcining, carbon dioxide (CO₂) is liberated from the calcium carbonate (CaCO₃), forming lime (CaO).

At between about 950-1300° C., the calcite, quartz, and clays react to form dicalcium silicate (C₂S). At between about 1300 and 1450° C., tricalcium silicate (C₃S) is formed through the reaction of dicalcium silicate (C₂S) and lime (CaO). During the process, the materials partially fuse into balls, ⅛ to 1 inch in diameter, known as clinker. Fusing is defined as a process of uniting materials by melting them together.

Once the clinker exits the rotary kiln, it is typically cooled in a cooling zone, ground to a fine powder, and subsequently mixed with an extender to prevent flash-setting of the cement.

The four major constituents of cement are tricalcium silicate (C₃S), dicalcium silicate (C₂S), tricalcium aluminate (C₃A), and tetracalcium aluminoferrite (C₄AF). Tricalcium silicate (C₃S) and dicalcium silicate (C₂S) are the most important compounds, which are responsible for the strength of the hydrated cement. Tricalcium aluminate (C₃A) and tetracalcium aluminoferrite (C₄AF) do not contribute to the strength of the cement, but help with some of the reactions of cement. Tricalcium silicate (C₃S) is the primary compound of the cement, ranging from between about 40 to 70% of the cement. The amount of dicalcium silicate (C₂S) ranges from between about 15 to 30% of the cement. The amounts of tricalcium aluminate (C₃A) and tetracalcium aluminoferrite (C₄AF) each range from between about 2 to 16% of the cement. The percentage of each component depends on the type of product.

During the cement making process, cement kiln dust (CKD) is often generated. CKD is defined as waste recovered from the exhaust gases of pollution control equipment associated with the rotary kilns. The dust is picked up at different locations along the kiln, thus resulting in a mixed product. Mid-kiln dust scoops are known in the art, which enable the CKD to be pneumatically put back into the kiln. In particular, the mid-kiln dust scoops are located in the calcining zone of the rotary kiln, and allow the CKD to be reused in the process. The CKD has a very fine consistency, and readily combines with the raw feed material to form clinker.

Other waste materials have been used in the cement making process. In particular, blast furnace slag has been used in the cement making process. Blast furnace slag is a by-product from the production of iron in a blast furnace. For example, U.S. Pat. No. 5,976,243 discloses adding blast furnace slag to the cement clinker in the cooling zone of a cement kiln assembly to drive off water in the slag and produce a blended mixture of cement clinker and blast furnace slag.

U.S. Pat. No. 5,494,515 discloses feeding blast furnace slag at the feed end of the rotary kiln. Before feeding the blast furnace slag into the feed end of the rotary kiln, the slag must be crushed and screened to provide a coarse state with a predominant particle size having diameters up to 2 inches. The stated advantage of the process disclosed therein, as opposed to processes where the blast furnace slag is fed at a heat end of the kiln, is that fine grinding of the blast furnace slag is not necessary. Similarly, U.S. Pat. No. 5,421,880 describes a process for feeding steel slag at a feed end of the rotary kiln, where the steel slag has a predominant particle size with diameters up to 2 inches. However, blast furnace slag and steel slag can be found in particles well above 2 inches. Therefore, there is a need in the art for a cement making process which will reduce the crushing, screening, and grinding necessary to feed the slag into the process.

In addition, there are other waste materials that are produced in industrial processes, such as from the paper, gypsum, aluminum, steel, and iron industries. Manufacturers in these areas are often faced with the problem of disposing of these materials, which could be an environmental concern. In addition, these waste materials have properties that will allow them to be recycled by using them in a cement making process. Therefore, there is a need in the art for reusing other waste materials in a cement making process, such as high carbon fly ash, fly ashes, and bottom ashes.

Further, in conventional cement making processes, raw material feed, such as limestone, sand, clay, slag, fly ash, and mill scale, is crushed, ground into a slurry, pumped to blending tanks, proportioned and blended to the desired chemistry, and pumped to the kilns as feed material. Typically, these materials are fed as a wet slurry. Each of these steps is energy intensive and costly. For example, when using a wet slurry, the mixture must be heated to drive off the water. A significant amount of heat and energy is required for drying a wet slurry. Therefore, there is a need in the art to minimize the amount of wet material fed at the feed end of the rotary kiln.

In addition, the abrasiveness of the raw feed material causes significant wear of the apparatus. For example, chain systems are often used to efficiently transfer heat to the feed material and to transport the raw feed as it is transformed from an aqueous slurry to a very viscous and slow moving mass, and finally to a granular or powdery state at low moisture. These systems are subject to extreme wear, and must often be replaced. Therefore, there is a need in the art to decrease the wear on chain systems.

### SUMMARY

In light of the foregoing, one aspect of the present invention involves a method of manufacturing cement clinker in a rotary cement kiln having a feed end, a mid-kiln feed location, and a burning end. The rotary kiln is tilted downwardly from the feed end to the burning end so that material introduced into the feed end travels downwardly to the burning end. Heat is directed at the burning end of the rotary kiln. Raw feed material is introduced in the feed end of the rotary kiln. Material having a particle diameter up to 12 inches are introduced in at the mid-kiln feed location, the mid-kiln feed location being arranged in a calcining zone of the rotary kiln, wherein the introduced material is selected from the group consisting of limestone, clay, slag including blast furnace slag and steel slag, bottom ash, fly ash, underburned clinker, and silica bearing materials. The mid-kiln feed location is arranged in a calcining zone of the rotary kiln.

Another aspect of the invention involves a method of manufacturing cement clinker using blast furnace slag in a rotary cement kiln having a feed end, a mid-kiln feed location, and a burning end. The rotary kiln is tilted downwardly from the feed end to the burning end so that material introduced into the feed end travels downwardly to the burning end. Heat is directed at the burning end of the rotary kiln. Raw feed material is introduced in the feed end of the rotary kiln. Blast furnace slag is introduced at the mid-kiln feed location. The mid-kiln feed location is arranged in a calcining zone of the rotary kiln.

Another aspect of the invention involves a method of manufacturing cement clinker in a rotary cement kiln having a feed end, a mid-kiln feed location, and a burning end. The rotary kiln is tilted downwardly from the feed end to the burning end so that material introduced into the feed end travels downwardly to the burning end. Heat is directed at the burning end of the rotary kiln. Raw feed material is introduced in the feed end of the rotary kiln. Raw feed material is also introduced at the mid-kiln feed location. The mid-kiln feed location is arranged in a calcining zone of the rotary kiln.

### BRIEF DESCRIPTION OF THE DRAWINGS

Further features and characteristics of the present invention will become more apparent from the following detailed description considered with reference to the accompanying drawings.

FIG. 1 is a schematic of a kiln assembly according to the prior art.

FIG. 2 is a schematic of a kiln assembly, including a mid-kiln feed location.

FIG. 3 is a cross sectional view of the mid-kiln feed location taken along line of A-A of FIG. 2.

FIG. 4 is a schematic of the addition of waste materials to the rotary kiln at the mid-kiln feed location.

### DETAILED DESCRIPTION OF THE PREFERRED EMBODIMENTS

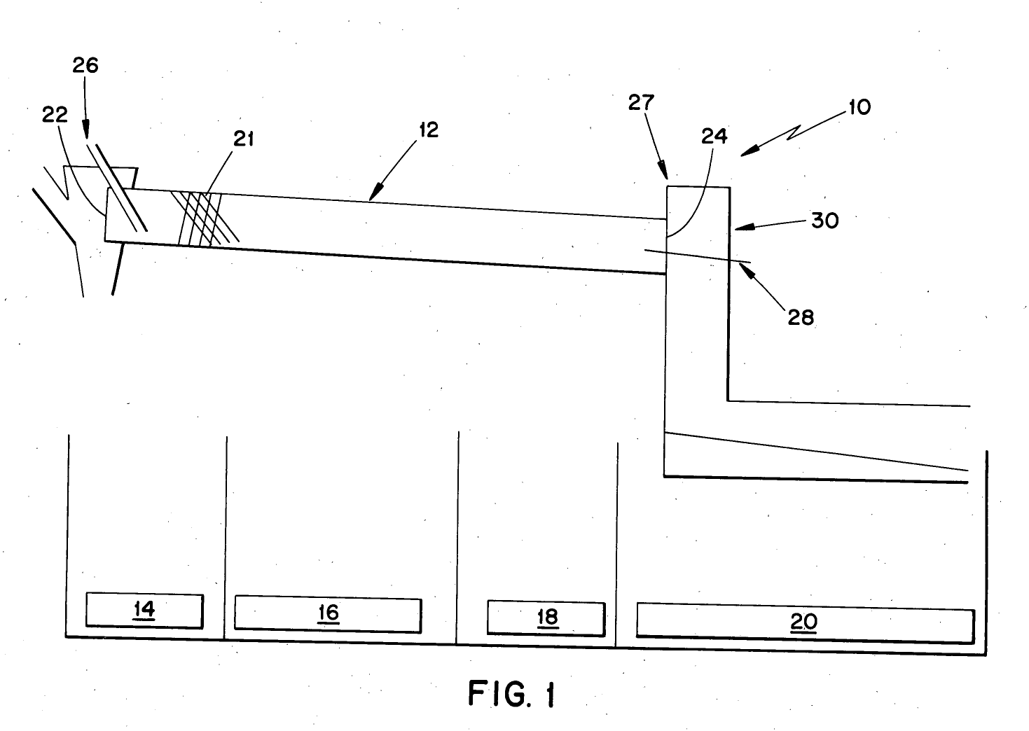

With reference to FIG. 1, a kiln assembly 10 for a cement making process includes a rotary kiln 12, which rotates about its longitudinal axis. The kiln 12 is constructed in a conventional manner, and has a number of operating zones to process raw feed materials to cement clinker. In a dry or wet process, the rotary kiln 12 has a calcining zone 16, a burning zone 18, and a cooling zone 20. For wet processes, rotary kiln 12 preferably has a drying zone 14 to remove the excess moisture from the raw feed materials. In addition, a chain system 21 may be provided to help transfer heat to and remove moisture from the raw feed materials.

The rotary kiln 12 is tilted downwardly from a feed end 22 to a burning end 24. Raw feed materials are fed into the kiln 12 at the feed end 22. Raw feed materials include limestone, clay, sand, or the like, which are finely ground and fed to the rotary kiln 12 via a feed pipe 26. However, it should be understood that the raw feed materials may be fed by other devices known in the art, depending on design preference and application. Furthermore, the present invention is not limited to applications where only raw feed materials are fed in at the feed end.

A burner assembly 27 is mounted externally of the kiln 12. The burner assembly 27 includes a burner pipe 28 mounted in a firing hood 30. The burner pipe 28 extends through the burning end 24 of rotary kiln 12. Conventional fuel mixed with pre-heated air is injected into the kiln via the burner pipe 28. However, it should be understood that other devices may heat the burning end of the rotary kiln, depending on application and design preference.

The raw feed materials are fed at the feed end 22 of the kiln 12, where they preferably enter the drying zone 14. In the drying zone 14, the temperature typically ranges from between about 300° C. to about 600° C., which drives off excess water from the slurry. However, it should be understood that this range may be greater or smaller, depending on the raw feed materials fed to the rotary kiln. In addition, a drying zone is typically only used for wet slurries, and is not required for dry raw feed.

The materials then proceed through the calcining zone 16. In the calcining zone, the materials are heated to a high temperature, but below the melting point of the materials, causing loss of moisture, reduction of oxidation, and the decomposition of carbonates and other compounds. In the calcining zone 16, the temperature typically ranges from about 500° C. to 1200° C., and most preferably between about 650° C. to 900° C. However, it should be understood that this range may be greater or smaller, depending on the raw feed materials fed to the rotary kiln and the speed of the process. That is, the particular chemistry of the raw feed materials and the speed of the process impacts when calcining of the materials occur.

The materials then proceed to the burning or sintering zone 18. In the burning zone 18, the temperature typically is raised up to about 1600° C., and most preferably around 1500° C. However, it should be understood that the temperature of the burning zone 18 may be greater or smaller, depending on the raw feed materials fed to the rotary kiln and the speed of the process. In the burning zone 18, two primary reactions take place. At between about 950-1300° C., calcite, quartz, and decomposition of clays react to form dicalcium silicate (C₂S). At between about 1300 and 1450° C., tricalcium silicate (C₃S) forms through the reaction of dicalcium silicate (C₂S) and lime (CaO). It is in the burning zone that the raw feed materials are converted into the four main compounds of cement, i.e., tricalcium silicate (C₃S), dicalcium silicate (C₂S), tricalcium aluminate (C₃A), and tetracalcium aluminoferrite (C₄AF), and clinker is formed. The clinker is then preferably cooled in the cooling zone 20, and processed thereafter.

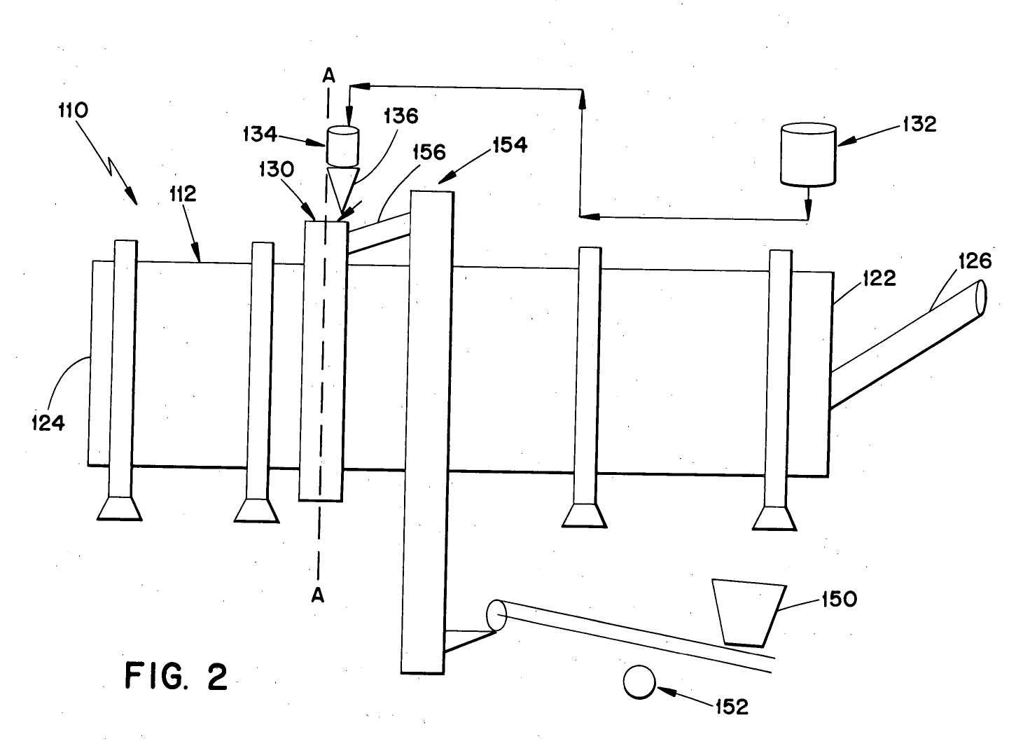

With reference to FIG. 2, an alternative type of kiln assembly 110 is illustrated. The kiln assembly 110 includes a rotary kiln 112 having a mid-kiln feed port 130. The mid-kiln port 130 is preferably located in the calcining zone of the rotary kiln 112.

Similar to the rotary kiln 12 of FIG. 1, the rotary kiln 112 has a feed end 122 and a burning end 124 where raw feed materials fed through a feed pipe 126 are directed towards the burning end 124 of the rotary kiln 112. However, an additional feed port 130 is provided at a mid-kiln location. The structure of the mid-kiln feed port 130 is known in the art and has been used in connection with CKD. In particular, CKD has been fed via a tank 132 to an alleviator 134, through a hopper 136, and into the mid-kiln feed port 130.

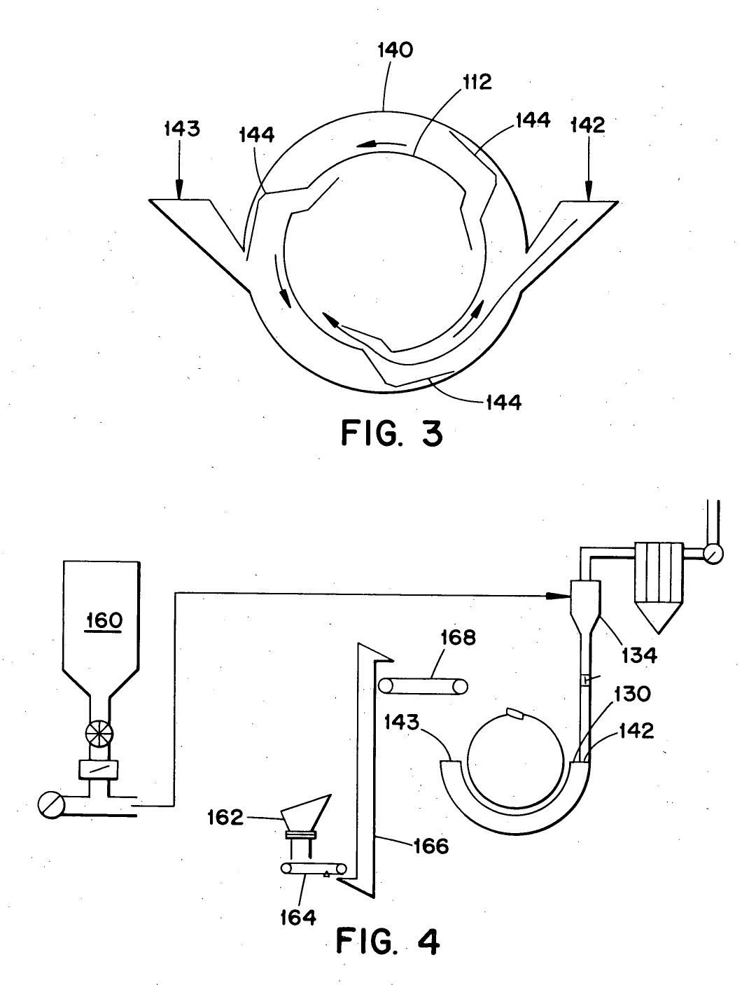

With reference to FIG. 3, a particular device that has been used in the past to introduce CKD into a rotary kiln is illustrated. In particular, the mid-kiln feed port 130 is preferably a dust scoop 140, which includes two spouts 142, 143. The two spouts 142, 143 remain fixed and stationary, as CKD is fed into the spout 142. The kiln 112, which is rotating during the process, includes protruding arms 144 which scoop the dust being added to the spout 142 into the kiln 112. As the dust enters the spout 142, the rotary kiln 112 rotates (counter-clockwise as seen in FIG. 3) and the material is fed into the kiln by way of the protruding arms 144. The spout 143 remains unused during the process. It should be understood that this apparatus is known in the art, and has been used in connection with recycling of CKD in the cement making process. However, it should be understood that the present invention is not limited to the particular structure of the mid-kiln port described herein. Rather, the present invention applies to any type of mid-kiln feed port that allows materials to be fed into the system.

One embodiment of the present invention provides a novel method, which allows waste materials, such as blast furnace slag, to be fed at the mid-kiln feed location. For example, blast furnace slag may be added to the rotary kiln at the mid-kiln feed location to form cement clinker. With reference to FIG. 2, blast furnace slag is added to the rotary kiln 112 from hopper 150. The blast furnace slag is weighed by the weight scale 152 and then fed via a vertical feed elevator 154 to the mid-kiln feed port 130 by way of a horizontal conveyor 156. While a vertical feed elevator 154 and the horizontal conveyor 156 are disclosed for transferring the blast furnace slag to the mid-kiln feed port 130, it should be understood that other methods of transferring the blast furnace slag are encompassed by this invention, depending on design preference and application.

Blast furnace slag is a by-product from the production of iron in a blast furnace. Silicon, calcium, aluminum, magnesium and oxygen are the major elemental components of the slag. Either air-cooled or water-cooled blast furnace slag can be used in accordance with the present invention. In addition, both granulated and pelletized blast furnace slag can be used in accordance with the present invention. Silicon, calcium, aluminum, magnesium and oxygen are the major elemental components of the slag. Blast furnace slag having a particle size of up to five inches can be added to existing mid-kiln dust scoops that have been used to recycle CKD. However, the use of more modern equipment will allow blast furnace slag to be fed up to particle sizes of 12 inches, or possibly greater.

In operation, conventional raw feed materials are fed through the feed pipe 126 into the kiln 112. The kiln 112 rotates slowly, thereby advancing raw feed materials slowly through the drying zone and calcining zone. Blast furnace slag is added at the mid-kiln feed port 130 and is mixed in the calcining zone of the kiln with the raw feed materials. In the calcining zone, the blast furnace slag readily mixes and chemically combines with the other raw feed materials. The mass then fuses into clinker at the burning zone of the kiln. In one embodiment, depending on the chemistry of the raw feed materials, up to 50% of the materials fed to the kiln can be blast furnace slag added to the mid-kiln feed port.

Alternatively, steel slag may be used at the mid-kiln feed location to form cement clinker. Steel slag is a by-product from the production of steel. Like the blast furnace slag, the steel slag can be added at a particle size of up to five inches to existing mid-kiln dust scoops, or up to 12 inches, or possibly greater, in more modern equipment. In one embodiment, depending on the chemistry of the raw feed materials, up to 50% of the materials fed to the kiln can be steel slag added to the mid-kiln feed port.

Other particles can be added to the process at the mid-kiln feed location. In particular, calcined materials can be added to the process at the mid-kiln feed location to form cement clinker product. Calcined materials include blast furnace slag, bottom ash, steel slag, fly ash, and other industrial calcined material from the paper, gypsum, aluminum, steel and iron industries, power generated stations, and natural occurring sources like natural pozzolans.

Calcined materials, which contain alumina, iron, silica, and calcium elements, are very similar to raw kiln feed. Due to the calcined material's chemistry, it readily mixes and chemically combines with the other ingredients in the mid-kiln location to form cement clinker. Because the calcined material has already been subjected to calcinization, time and energy are saved by adding the calcined material at a mid-kiln location. Calcination removes carbon dioxide and forms the compounds of calcium silicates, aluminates, and ferrites—which are the building blocks of Portland cement.

In addition, adding calcined material at a mid-kiln location lowers fuel consumption, reduces raw feed materials, reduces air emissions, lowers burning temperature, improves refractory life, reduces gas flow through the kiln, recovers higher secondary heat from the cooler, and results in an immediate increase in unit production at the equivalent fuel consumption. In particular, because the calcined materials can be fed dry, this avoids the cost of drying.

With reference to FIG. 4, addition of fly ash and bottom ash slag to the mid-kiln location is illustrated. Fly ash is a type of coal ash which is carried from the furnace by exhaust or flue gases. Coal ash is defined as the residue produced in coal burning furnaces from burning pulverized anthracite or lignite. Fly ash fed from tank 160 can be added to the mid-kiln feed port 130 through alleviator 134, in a manner similar to that described in connection with the addition of CKD. Preferably, the fly ash is pneumatically conveyed into the alleviator 134.

Bottom ash can also be fed to the mid-kiln feed port 130. Bottom ash is defined as particles collected at the base of a coal burning furnace as agglomerates. Preferably, bottom ash is fed from a hopper 162 to a first horizontal conveyor 164. The bottom ash is then fed from first conveyor 164 to a vertical conveyor 166 to a second horizontal conveyor 168. The second horizontal conveyor 168 then directs the bottom ash to the spout 142 of the mid-kiln feed port 130. The bottom ash is processed at the mid-kiln feed port 130 identically to the slags described above.

In addition to the materials described above, other materials can be added at the mid-kiln feed location. For example, other lime bearing or partially calcined materials may be added at the mid-kiln feed location, such as underburned clinker and the like. Depending on the chemistry of the materials added, up to 50% of the kiln's raw feed could be introduced at the mid-kiln feed location as dry materials. Feeding dry materials at the mid-kiln feed location has an immediate benefit, in that the BTU's required for drying a wet slurry are significantly reduced. Reduced gas volumes cause a reduction in the entrainment of particulate matter and an improvement in the system “dust loss”.

The following Example illustrates addition of blast furnace slag at a mid-kiln location. It is understood that the present invention is defined by the appended claims and not the specific details of this Example.

### EXAMPLE 1

Tests were carried out on clinker samples generated from the addition of blast furnace slag and steel slag at a mid-kiln location. The blast furnace slag and steel slag was obtained from Lafarge's Alternative Raw Materials Group. The tests were conducted over a 16-hour period of time. The amount of blast furnace slag and steel slag added was initially 6% of the total feed material during the first four hours, having a particle size of less than 5 inches in diameter. The amount of blast furnace slag and steel slag was then increased slowly to about 10% of the total feed materal. 94% of the raw feed material were comprised of traditional raw feed materials, including limestone, clay, and sand proportioned to give the chemistry desired. The resulting clinker chemistry was monitored and tested.

TABLE 1
Clinker Chemistry from Blast Furnace Slag Trial

| Time (hours) | % C₃S | % C₃A |
|---|---|---|
| 0 | 52.4 | 7.7 |
| 2 | 44.7 | 7.4 |
| 4 | 39.2 | 9.2 |
| 6 | 42.2 | 9.4 |
| 8 | 40.3 | 9.2 |
| 10 | 19.8 | 10.9 |
| 12 | 50.6 | 7.8 |
| 16 | 55.9 | 7.8 |

TABLE 2
Clinker Chemistry from Steel Slag Trial

| Time | % C₃S | % C₃A |
|---|---|---|
| 0 | 59.4 | 7.5 |
| 2 | 54.9 | 7.4 |
| 4 | 53.0 | 7.0 |
| 6 | 55.5 | 6.6 |
| 8 | 54.1 | 6.4 |
| 10 | 49.3 | 5.4 |
| 12 | 53.2 | 7.4 |
| 16 | 53.4 | 7.3 |

The tests confirmed that blast furnace slag and steel slag can be added at the mid-kiln location. All product samples were determined to be usable, although some samples would require further blending to reduce the variability of the final product, which is a common industry practice. In addition, the quantities of C₃S— the principal strength producing compound, and C₃A- the principal compound in early setting or hardening of the product, were within acceptable ranges. Mass balance calculations on clinker chemistry confirmed that a high percentage of slag combined to form clinker. The resulting clinker comprised 10% slag and 90% feed materials. The percentage of the individual components will vary to control the chemistry as desired. In particular, blast furnace slag and steel slag can be added at a rate of up to 50% of the clinker production, depending on the chemistry of the raw feed materials.

The principles, preferred embodiments and manner of use of the present invention have been described in the foregoing specification. However, the invention which is intended to be protected is not to be construed as limited to the particular embodiments described. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the invention be embraced thereby.

What is claimed is:

1. A method of manufacturing cement clinker in a rotary cement kiln having a feed end, a mid-kiln feed location, and a burning end, the rotary kiln being tilted downwardly from the feed end to the burning end so that material introduced into the feed end travels downwardly to the burning end, comprising:
directing heat at the burning end of the rotary kiln;
introducing raw feed material into the feed end of the rotary kiln; and
introducing material having a particle diameter up to 12 inches at the mid-kiln feed location, the mid-kiln feed location being arranged in a calcining zone of the rotary kiln, wherein the introduced material is selected from the group consisting of limestone, clay, slag including blast furnace slag and steel slag, bottom ash, fly ash, underburned clinker, and silica bearing materials.

2. The method of claim 1, wherein the introduced material is calcined material.

3. The method of claim 1, wherein the calcining zone is in the range of about 500 to 1200° C.

4. The method of claim 1, wherein the calcining zone is in the range of about 650 to 900° C.

5. The method of claim 1, wherein the materials introduced at the mid-kiln feed location have a particle diameter up to 5 inches.

6. The method of claim 1, further comprising the step of adding other raw feed material at the mid-kiln feed location.

7. The method of claim 2, wherein the calcined material fed at the calcining zone is substantially dry.

8. The method of claim 1, wherein up to 50% of material inputted is fed at the mid-kiln feed location.

9. The method of claim 6, wherein the raw feed material is wet or dry.

10. A method of manufacturing cement clinker in a rotary cement kiln having a feed end, a mid-kiln feed location, and a burning end, the rotary kiln being tilted downwardly from the feed end to the burning end so that material introduced into the feed end travels downwardly to the burning end, comprising:
directing heat at the burning end of the rotary kiln;
introducing raw feed material into the feed end of the rotary kiln; and
introducing blast furnace or steel slag at the mid-kiln feed location, the mid-kiln feed location being arranged in a calcining zone of the rotary kiln.

11. The method of claim 10, wherein the blast furnace or steel slag fed at the calcining zone is substantially dry.

12. The method of claim 10, wherein the blast furnace or steel slag has a particle diameter up to 12 inches.

13. The method of claim 10, wherein the blast furnace or steel slag has a particle diameter of 5 inches or less.

14. The method of claim 10, wherein up to the blast furnace or steel slag added is up to 50% of material inputted to the rotary kiln.

15. The method of claim 10, further comprising the step of adding limestone and other raw feed material at the mid-kiln feed location.

16. The method of claim 10, wherein the slag is blast furnace slag.

17. The method of claim 10, wherein the slag is steel slag.

18. A method of manufacturing cement clinker in a rotary cement kiln having a feed end, a mid-kiln feed location, and a burning end, the rotary kiln being tilted downwardly from the feed end to the burning end so that material introduced into the feed end travels downwardly to the burning end, comprising:
directing heat at the burning end of the rotary kiln;
introducing raw feed material into the feed end of the rotary kiln; and
introducing raw feed material at the mid-kiln feed location, the mid-kiln feed location being arranged in a calcining zone of the rotary kiln.

19. The method of claim 18, wherein the raw feed material fed at the mid-kiln feed location has a particle diameter of up to 12 inches.

20. The method of claim 18, wherein the raw feed material fed at the mid-kiln feed location has a particle diameter of 5 inches or less.

21. The method of claim 18 wherein the raw feed material is limestone.

22. The method of claim 18, wherein the raw feed material is substantially dry.
